(19) United States
(12) Patent Application Publication
(10) Pub. No.: US 2026/0121076 A1
(43) Pub. Date: Apr. 30, 2026

(54) Positive Electrode for Secondary Battery, and Secondary Battery

(71) Applicant: Murata Manufacturing Co., Ltd., Nagaokakyo-shi, Kyoto-fu (JP)

(72) Inventor: Shogo KANBE, Nagaokakyo-shi, Kyoto-fu (JP)

(21) Appl. No.: 19/054,491

(22) Filed: Feb. 14, 2025

Related U.S. Application Data
(63) Continuation of application No. PCT/JP2023/021491, filed on Jun. 9, 2023.

(30) Foreign Application Priority Data
Sep. 28, 2022 (JP) 2022-154635

(51) Int. Cl. H01M 4/74; H01M 4/02; H01M 4/66; H01M 10/052

(52) U.S. Cl. CPC H01M 4/74; H01M 4/663; H01M 10/052; H01M 2004/021; H01M 2004/028

(57) ABSTRACT

A secondary battery that includes a positive electrode, a negative electrode, and an electrolytic solution. The positive electrode includes a positive electrode active material and a plurality of fibrous materials. The fibrous materials are tangled with each other and form a three-dimensional mesh structure. The fibrous materials each include a carbon fiber part, and a plurality of carbon covering parts that cover a surface of the carbon fiber part and hold the positive electrode active material. The carbon covering parts are spaced from each other in an extending direction of the carbon fiber part. The carbon fiber part includes a plurality of exposed parts that are not covered with the carbon covering parts. The fibrous materials have a flexibility F that is higher than or equal to 8.6 and lower than or equal to 19.2.

### CROSS REFERENCE TO RELATED APPLICATIONS

The present application is a continuation of International application No. PCT/JP2023/021491, filed Jun. 9, 2023, which claims priority to Japanese Patent Application No. 2022-154635, filed Sep. 28, 2022, the entire contents of each of which are incorporated herein by reference.

### TECHNICAL FIELD

The technology relates to a positive electrode for a secondary battery, and to a secondary battery.

### BACKGROUND ART

Various kinds of electronic equipment, including mobile phones, have been widely used. Such widespread use has promoted development of a secondary battery as a power source that is smaller in size and lighter in weight and allows for a higher energy density. A secondary battery includes a positive electrode (an electrode for a secondary battery), a negative electrode, and an electrolytic solution.

In particular, a secondary battery has been known that includes a sulfur-containing material as a positive electrode active material, and a configuration of the secondary battery has been considered in various ways. Specifically, in a positive electrode, carbon nanotubes are tangled with each other, a carbon layer covers a surface of each of the carbon nanotubes, and the carbon layer is co-doped with sulfur and nitrogen (see PTL 1). In a positive electrode, a highly graphitic porous carbon material covers a conductive core material, and sulfur is sealed in a plurality of pores (see PTL 2).
PTL 1: Japanese Unexamined Patent Application Publication No. 2020-031045
PTL 2: Japanese Patent No. 6726279

### SUMMARY OF THE DISCLOSURE

Although consideration has been given in various ways regarding a configuration of a secondary battery, there are battery characteristics of the secondary battery that are not yet sufficient. Accordingly, there is room for improvement in terms of the battery characteristics of the secondary battery.

It is desirable to provide a positive electrode for a secondary battery, and a secondary battery that each make it possible to achieve a superior battery characteristic.

A positive electrode for a secondary battery according to one embodiment of the technology includes: a positive electrode active material; and a plurality of fibrous materials, wherein the positive electrode active material includes a sulfur-containing material, the plurality of fibrous materials are tangled with each other and form a three-dimensional mesh structure, the plurality of fibrous materials each include: a carbon fiber part, and a plurality of carbon covering parts that cover a surface of the carbon fiber part and hold the positive electrode active material, the plurality of carbon covering parts are spaced from each other in an extending direction of the carbon fiber part, the carbon fiber part includes a plurality of exposed parts that are not covered with the carbon covering parts, the plurality of carbon covering parts each have a first end in the extending direction of the carbon fiber part, and a second end opposite to the first end, and the plurality of fibrous materials have a flexibility F that is higher than or equal to 8.6 and lower than or equal to 19.2, wherein F=(L2/L1)×T where L1 is a length, in micrometers, of the carbon fiber part in the extending direction of the carbon fiber part, L2 is a sum total, in micrometers, of respective lengths of the plurality of exposed parts in the extending direction of the carbon fiber part, and T is a sum total, in number, of a number of the first ends and a number of the second ends.

A secondary battery according to one embodiment of the technology includes a positive electrode, a negative electrode, and an electrolytic solution. The positive electrode has a configuration similar to that of the positive electrode for the secondary battery according to one embodiment of the technology described above.

Note that a definition of the flexibility F, a method of calculating the flexibility F, etc. will be described in detail later.

According to the positive electrode for the secondary battery of one embodiment of the technology or the secondary battery of one embodiment of the technology, the positive electrode for the secondary battery includes the positive electrode active material and the fibrous materials. The positive electrode active material includes the sulfur-containing material. The fibrous materials are tangled with each other and form the three-dimensional mesh structure. The fibrous materials each include the carbon fiber part and the carbon covering parts. The carbon covering parts cover the surface of the carbon fiber part and hold the positive electrode active material. The carbon covering parts are spaced from each other in the extending direction of the carbon fiber part. The carbon fiber part includes the exposed parts that are not covered with the carbon covering parts. The carbon covering parts each have the first end and the second end in the extending direction of the carbon fiber part. The fibrous materials have the flexibility F that is higher than or equal to 8.6 and lower than or equal to 19.2. This makes it possible to achieve a superior battery characteristic.

Note that effects of the technology are not necessarily limited to those described above and may include any of a series of effects described below in relation to the technology.

### BRIEF DESCRIPTION OF DRAWINGS

FIG. 1 is a sectional diagram illustrating a configuration of a positive electrode for a secondary battery according to one embodiment of the technology.

FIG. 2 is a plan diagram illustrating a configuration of a positive electrode active material layer illustrated in FIG. 1.

FIG. 3 is a plan diagram illustrating a configuration of a fibrous material illustrated in FIG. 1.

FIG. 4 is a plan diagram for describing a definition of a flexibility.

FIG. 5 is a perspective diagram illustrating a configuration of a secondary battery according to one embodiment of the technology.

FIG. 6 is a sectional diagram illustrating a configuration of a battery device illustrated in FIG. 5.

FIG. 7 is a block diagram illustrating a configuration of an application example of the secondary battery.

FIG. 8 is a sectional diagram illustrating a configuration of a test secondary battery.

### DESCRIPTION OF THE PREFERRED EMBODIMENTS

Some embodiments of the technology are described below in detail with reference to the drawings. The description is given in the following order.
1. Positive Electrode for Secondary Battery
1-1. Configuration
1-2. Operation
1-3. Manufacturing Method
1-4. Action and Effects
2. Secondary Battery
2-1. Configuration
2-2. Operation
2-3. Manufacturing Method
2-4. Action and Effects
3. Modification Examples
4. Applications of Secondary Battery

### 1. POSITIVE ELECTRODE FOR SECONDARY BATTERY

A description is given first of a positive electrode for a secondary battery (hereinafter simply referred to as the “positive electrode”) according to an embodiment of the technology.

The positive electrode to be described here is to be used in a secondary battery, which is an electrochemical device. However, the positive electrode may be used in electrochemical devices other than a secondary battery. Specific examples of the other electrochemical devices include a primary battery and a capacitor.

The positive electrode allows an electrode reactant to be inserted into and extracted from the positive electrode upon an operation (an electrode reaction) of the electrochemical device. Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

The following description deals with an example case in which the electrode reactant is lithium. Lithium is thus inserted into and extracted from the positive electrode in an ionic state upon the electrode reaction.

### [1-1. Configuration]

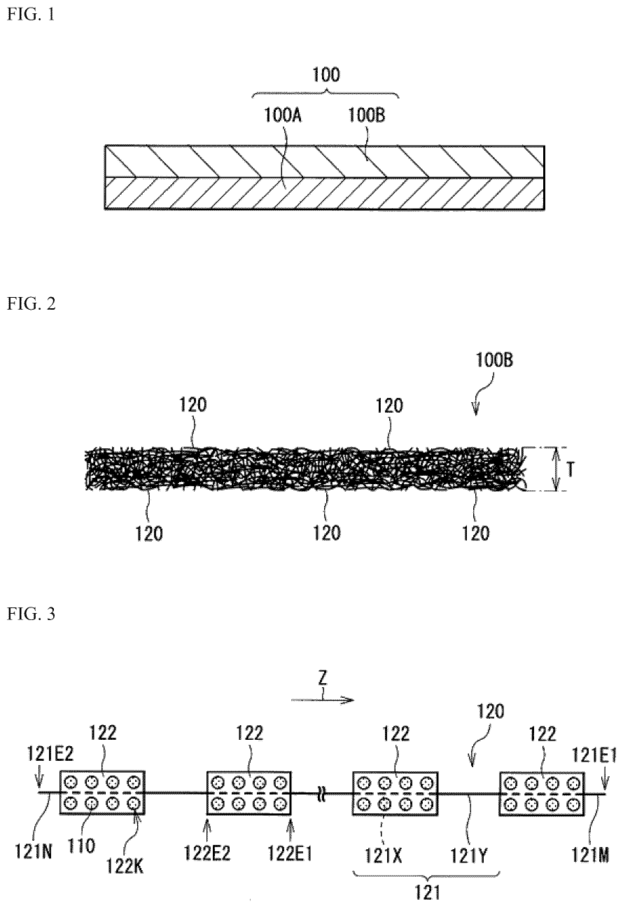

FIG. 1 illustrates a sectional configuration of a positive electrode 100 as a specific example of the positive electrode. FIG. 2 illustrates a plan configuration of a positive electrode active material layer 100B illustrated in FIG. 1. FIG. 3 illustrates a plan configuration of a fibrous material 120 illustrated in FIG. 1.

The positive electrode 100 includes, as illustrated in FIG. 1, a positive electrode current collector 100A and the positive electrode active material layer 100B.

### [Positive Electrode Current Collector]

As illustrated in FIG. 1, the positive electrode current collector 100A is an electrically conductive support that supports the positive electrode active material layer 100B, and has two opposed surfaces on each of which the positive electrode active material layer 100B is to be provided. The positive electrode current collector 100A includes an electrically conductive material such as a metal material. Specific examples of the electrically conductive material include aluminum.

### [Positive Electrode Active Material Layer]

The positive electrode active material layer 100B is a layer into which the electrode reactant is insertable and from which the electrode reactant is extractable. The positive electrode active material layer 100B is provided on one of the two opposed surfaces, e.g., an upper surface, of the positive electrode current collector 100A, as illustrated in FIG. 1. However, the positive electrode active material layer 100B may be provided on each of the two opposed surfaces, e.g., the upper surface and a lower surface, of the positive electrode current collector 100A.

As illustrated in FIGS. 2 and 3, the positive electrode active material layer 100B includes a positive electrode active material 110 and a plurality of fibrous materials 120. The positive electrode active material layer 100B has a substantially flat-plate-shaped structure, and thus has a thickness T (μm). The thickness T is not particularly limited, and may thus be set as desired.

### [Positive Electrode Active Material]

The positive electrode active material 110 includes a material into which lithium is insertable and from which lithium is extractable. More specifically, the positive electrode active material 110 includes any one or more of sulfur-containing materials. In FIG. 2, illustration of the positive electrode active material 110 is omitted. In FIG. 3, the positive electrode active material 110 is shaded.

The positive electrode active material 110 is held by the fibrous materials 120 (carbon covering parts 122), as will be described later. A configuration in which the positive electrode active material layer 100B is held by the fibrous materials 120 will be described in detail later.

The term “sulfur-containing material” is a generic term for a material including sulfur as a constituent element. The sulfur-containing material may be a simple substance, an alloy, a compound, a mixture of two or more thereof, or a material including one or more phases thereof. The term “simple substance” described here merely refers to a simple substance in a general sense. The simple substance may therefore include a small amount of impurity. That is, purity of the simple substance does not necessarily have to be 100%.

### [Fibrous Materials]

As illustrated in FIGS. 2 and 3, the fibrous materials 120 are tangled with each other and hold the positive electrode active material 110, and thus form a three-dimensional mesh structure. That is, the positive electrode active material layer 100B includes the three-dimensional mesh structure in which the fibrous materials 120 are tangled with each other.

For easier understanding of a configuration of each of the fibrous materials 120, FIG. 3 illustrates the fibrous material 120 in a straightly extending state. Here, the fibrous material 120 extends in an extending direction Z along a longitudinal direction.

The fibrous material 120 includes a carbon fiber part 121 and the plurality of carbon covering parts 122, as illustrated in FIG. 3.

### [Carbon Fiber Part]

As illustrated in FIG. 3, the carbon fiber part 121 is a fibrous electrically conductive material that supports the carbon covering parts 122, and extends in the extending direction Z.

The carbon fiber part 121 thus has a front end part 121M as a first end part, and a rear end part 121N as a second end part. The front end part 121M is at a front position in the extending direction Z. The rear end part 121N is at a rear position in the extending direction Z. That is, the rear end part 121N is positioned on an opposite side to the front end part 121M in the extending direction Z. Here, as is apparent from FIG. 3, because the extending direction Z is a rightward direction, the front end part 121M is a right end part, and the rear end part 121N is a left end part.

In addition, the carbon fiber part 121 has a front end 121E1 and a rear end 121E2. The front end 121E1 is at a front position in the extending direction Z. The rear end 121E2 is at a rear position in the extending direction Z. That is, the rear end 121E2 is positioned on an opposite side to the front end 121E1 in the extending direction Z. Here, as is apparent from FIG. 3, because the extending direction Z is the rightward direction, the front end 121E1 is a right end, and the rear end 121E2 is a left end.

The carbon covering parts 122 cover a surface of the carbon fiber part 121, and are spaced from each other in the extending direction Z, as will be described later. The carbon fiber part 121 thus includes a plurality of unexposed parts 121X and a plurality of exposed parts 121Y. The unexposed parts 121X are covered with the respective carbon covering parts 122. The exposed parts 121Y are not covered with the carbon covering parts 122.

In the positive electrode active material layer 100B, the fibrous materials 120 are tangled with each other to form the three-dimensional mesh structure, as described above. Accordingly, the carbon fiber parts 121 are tangled with each other, and the carbon fiber parts 121 are thus coupled to each other. Inside the positive electrode active material layer 100B, the carbon fiber parts 121 are thus electrically coupled to each other, which allows for formation of a three-dimensional electrically conductive network by such carbon fiber parts 121.

Here, the fibrous material 120 includes the carbon covering parts 122, and the carbon fiber part 121 includes the unexposed parts 121X and the exposed parts 121Y, as described above.

In this case, the front end part 121M may be covered with the carbon covering part 122, or may not be covered with the carbon covering part 122. In particular, it is preferable that the front end part 121M be not covered with the carbon covering part 122 and be exposed, as illustrated in FIG. 3. One reason for this is that this allows the front end part 121M to be bent easily, which in turn allows the fibrous material 120 as a whole to be bent easily. Note that when the front end part 121M is exposed, the exposed front end part 121M serves as one of the exposed parts 121Y.

The above description regarding the front end part 121M similarly applies to the rear end part 121N. That is, the rear end part 121N may be covered with the carbon covering part 122, or may not be covered with the carbon covering part 122 and be exposed. In particular, however, it is preferable that the rear end part 121N be exposed, as illustrated in FIG. 3. One reason for this is that this allows the rear end part 121N to be bent easily, which in turn allows the fibrous material 120 as a whole to be bent easily. Note that when the rear end part 121N is exposed, the exposed rear end part 121N serves as one of the exposed parts 121Y.

The carbon fiber part 121 includes any one or more of fibrous carbon materials. The fibrous carbon materials are not particularly limited in kinds, and specific examples thereof include a carbon nanotube and a carbon nanofiber. One reason for this is that this makes it easier for the three-dimensional electrically conductive network to be formed stably by the carbon fiber parts 121. Note that the carbon nanotube may be a single-walled carbon nanotube (SWCNT), may be a multi-walled carbon nanotube (MWCNT), or may include both.

For example, the carbon fiber parts 121 is not particularly limited in, for example, average fiber diameter and in average length, and may have, for example, an average fiber diameter and an average length that are set as desired.

### [Carbon Covering Parts]

The carbon covering parts 122 are each a lump-shaped electrically conductive member that covers a surface or a periphery of the carbon fiber part 121 and holds the positive electrode active material 110, as illustrated in FIG. 3. Note that the carbon covering parts 122 are spaced from each other in the extending direction Z, as described above. In other words, the carbon covering parts 122 are discontinuous with each other in the extending direction Z and are separated from each other in the extending direction Z.

The carbon covering parts 122 each thus have a front end 122E1 as a first end, and a rear end 122E2 as a second end. The front end 122E1 is at a front position in the extending direction Z. The rear end 122E2 is at a rear position in the extending direction Z. That is, the rear end 122E2 is positioned on an opposite side to the front end 122E1 in the extending direction Z. Here, as is apparent from FIG. 3, because the extending direction Z is the rightward direction, the front end 122E1 is a right end, and the rear end 122E2 is a left end. The carbon covering parts 122 each thus have the front end 122E1 and the rear end 122E2.

The carbon covering parts 122 cover the surface of the carbon fiber part 121, and are thus in contact with the surface of the carbon fiber part 121. Accordingly, the carbon fiber part 121 and each of the carbon covering parts 122 are electrically coupled to each other.

The carbon covering parts 122 hold the positive electrode active material 110, as described above. A configuration in which the carbon covering parts 122 hold the positive electrode active material 110 is not particularly limited.

In particular, it is preferable that the carbon covering parts 122 have a plurality of fine pores 122K, and the positive electrode active material 110 be disposed in the fine pores 122K. One reason for this is that this makes it easier for the positive electrode active material 110 to be held more stably by the carbon covering parts 122 and makes it easier for the positive electrode active material 110 and the carbon covering parts 122 to be communicable with each other, which in turn makes it easier for lithium to be stably and smoothly inserted into and extracted from the positive electrode active material layer 100B. In this case, in particular, a rate of the positive electrode active material 110 that becomes inactive due to a reaction between the positive electrode active material 110 and the electrolytic solution decreases. This improves lithium diffusivity and increases an energy density.

The carbon covering parts 122 each include any one or more of non-fibrous carbon materials. The non-fibrous carbon materials are not particularly limited in kinds, and specific examples thereof include activated carbon. One reason for this is that this makes it easier for the fine pores 122K to be stably formed in the carbon covering parts 122, which in turn makes it easier for the positive electrode active material 110 to be stably disposed in the fine pores 122K.

### [Flexibility]

In the positive electrode 100, in order to improve a filling characteristic of the fibrous materials 120, more specifically, to increase a density of the three-dimensional mesh structure formed by the fibrous materials 120, a predetermined condition is satisfied regarding a flexible characteristic of the fibrous materials 120. In the following, a description is given of a flexibility F that is an index representing the flexible characteristic of the fibrous materials 120.

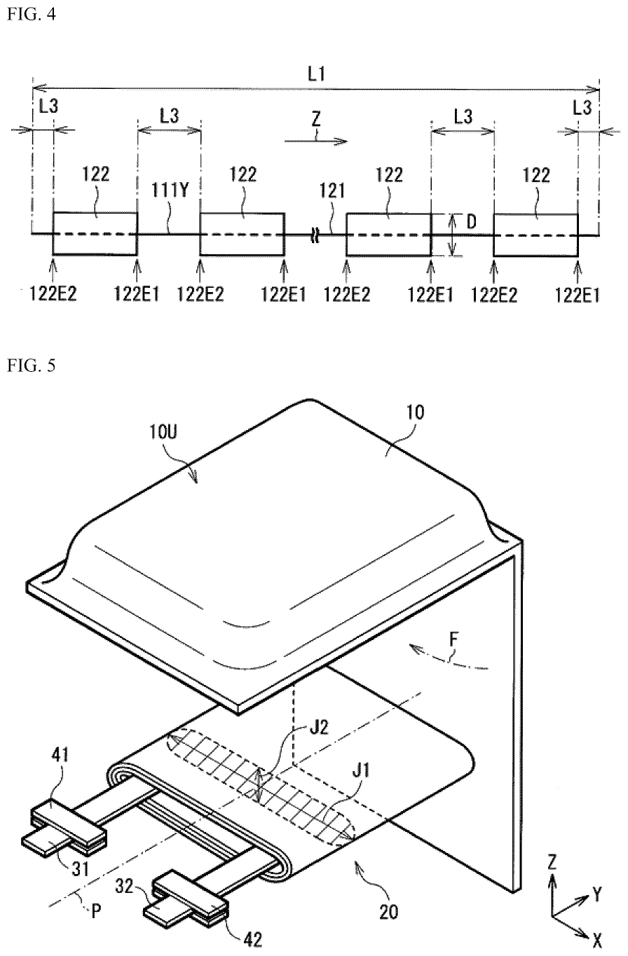

FIG. 4 illustrates a plan configuration of the fibrous material 120 corresponding to FIG. 3, for describing a definition of the flexibility F. Note that for simpler illustration, FIG. 4 omits illustration of each of the positive electrode active material 110 and the fine pores 122K. In the following, FIG. 3, which has already been described, will be referred to where appropriate, together with FIG. 4.

### Definition

The flexibility F is a coefficient represented by Expression (1), and represents the flexible characteristic of the fibrous material 120, as described above.

$$F = ( L 2 / L 1 ) \times T \qquad ( 1 )$$

where:
F is the flexibility;
L1 is a length (μm) of the carbon fiber part 121 in the extending direction Z;
L2 is a sum total (μm) of respective lengths L3 of the exposed parts 121Y in the extending direction Z; and
T is a sum total (number) of number of the front ends 122E1 and number of the rear ends 122E2.

As described above, the length L1 (μm) is a dimension (a length) of the carbon fiber part 121 in the extending direction Z. Accordingly, the length L1 is a distance from the front end 121E1 to the rear end 121E2, as illustrated in FIGS. 3 and 4.

As described above, the sum total L2 (μm) is the sum total of the respective dimensions (the respective lengths L3) of the exposed parts 121Y in the extending direction Z. In other words, where a dimension (a distance) of the exposed part 121Y in the extending direction Z is the length L3, the sum total L2 is the sum total of the lengths L3.

Note that in FIG. 4, because the illustration is simplified as described above, only four lengths L3 are illustrated. In the illustrated case, because the front end part 121M is the exposed part 121Y as described above, the length L3 of the front end part 121M (the exposed part 121Y) is to be taken into account in calculating the sum total L2. Similarly, because the rear end part 121N is the exposed part 121Y as described above, the length L3 of the rear end part 121N (the exposed part 121Y) is to be taken into account in calculating the sum total L2.

The sum total T (the number) is the sum total of the number of the front ends 122E1 and the number of the rear ends 122E2. Accordingly, the sum total T has a value that is a multiple of two. More specifically, the sum total T has the following value: number of carbon covering parts 122×2.

For example, when the number of the carbon covering parts 122 is two, because each of the two carbon covering parts 122 has the front end 122E1 and the rear end 122E2, the sum total T becomes 4 as follows: sum total T=(number of front ends 122E1 (=1)×2)+(number of rear ends 122E2 (=1)×2)=4.

To give another example, when the number of the carbon covering parts 122 is three, because each of the three carbon covering parts 122 has the front end 122E1 and the rear end 122E2, the sum total T becomes 6 as follows: sum total T=(number of front ends 122E1 (=1)×3)+(number of rear ends 122E2 (=1)×3)=6.

Accordingly, an increase in the flexibility F makes it easier for the fibrous material 120 to be bent by utilizing the carbon fiber part 121 (the exposed parts 121Y), and thus makes it easier for the fibrous materials 120 to be so tangled with each other that the carbon covering parts 122 fill a gap. This increases the density of the three-dimensional mesh structure formed by the fibrous materials 120, and thus improves the filling characteristic of the fibrous materials 120.

In contrast, a decrease in the flexibility F makes it more difficult for the fibrous material 120 to be bent by utilizing the carbon fiber part 121 (the exposed parts 121Y), and thus makes it more difficult for the fibrous materials 120 to be so tangled with each other that the carbon covering parts 122 fill the gap. This decreases the density of the three-dimensional mesh structure formed by the fibrous materials 120, and thus deteriorates the filling characteristic of the fibrous materials 120.

### [Range]

The flexibility F is within a range from 8.6 to 19.2 both inclusive. One reason for this is that this allows the flexible characteristic of the fibrous materials 120 to be appropriate, which appropriately improves the filling characteristic of the fibrous materials 120. Accordingly, while the three-dimensional electrically conductive network formed by the carbon fiber parts 121 is maintained, and lithium insertability and extractability in each of the carbon covering parts 122 (the positive electrode active material 110) are secured, the density of the positive electrode active material layer 100B increases. This allows an electrode density of the positive electrode 100 to increase. Note that the value of the flexibility F is rounded to one decimal place.

### [Calculation Method]

The flexibility F is to be calculated by the following procedure. Note that when the secondary battery is used to calculate the flexibility F, the positive electrode 100 is collected from the secondary battery, and the flexibility F is thereafter calculated by the following procedure.

First, the positive electrode 100 is cut in a thickness direction to expose a section of the positive electrode 100. The thickness direction refers to a direction along the thickness T, i.e., an up-down direction in each of FIGS. 1 and 2. In this case, for example, a high-precision electrode puncher is used as a cutting tool. Note that if the cutting crushes the section of the positive electrode 100, and makes it difficult to observe the section of the positive electrode 100 in a later process, any one or more of processing methods including, without limitation, a focused ion beam (FIB) method and a cross-section polisher (CP) method may be used.

Thereafter, the section of the positive electrode 100 is observed with use of an electron microscope to acquire an observation result, e.g., an electron micrograph, of the section. An observation magnification may be set as desired, as long as the observation magnification allows for visual recognition and identification of the fibrous materials 120. The electron microscope is not particularly limited in kind, and specifically includes any one or more of electron microscopes including, without limitation, a scanning electron microscope and a transmission electron microscope.

Thereafter, based on the electron micrograph, one fibrous material 120 is selected for a calculation of the flexibility F. In this case, any one fibrous material 120 is selected from the fibrous materials 120 each having the front end part 121M and the rear end part 121N both visually recognizable in an electron microscope view.

That is, in the electron microscope view, multiple fibrous materials 120 are visually recognizable, and such fibrous materials 120 are classified into the following four kinds.

The fibrous material 120 of a first kind has the front end part 121M and the rear end part 121N that are both present in the electron microscope view, and thus allows for visual recognition of both the front end part 121M and the rear end part 121N thereof. The fibrous material 120 of a second kind has the front end part 121M and the rear end part 121N that are both absent in the electron microscope view, and thus does not allow for visual recognition of either the front end part 121M or the rear end part 121N thereof. The fibrous material 120 of a third kind has the front end part 121M present in the electron microscope view and the rear end part 121N absent in the electron microscope view, and thus allows for visual recognition only of the front end part 121M thereof. The fibrous material 120 of a fourth kind has the rear end part 121N present in the electron microscope view and the front end part 121M absent in the electron microscope view, and thus allows for visual recognition only of the rear end part 121N thereof.

That is, the fibrous material 120 of the first kind is entirely visually recognizable in the electron microscope view. In contrast, the fibrous material 120 of each of the second to fourth kinds is not entirely visually recognizable and only partially visually recognizable in the electron microscope view.

When one fibrous material 120 is to be selected for the calculation of the flexibility F, the fibrous material 120 to be selected is only of the first kind described above, and not of the second to the fourth kinds described above.

One reason for selecting only the fibrous material 120 of the first kind having the front end part 121M and the rear end part 121N that are both visually recognizable is that unless only the fibrous material 120 of the first kind is selected, reproducibility in counting the number of each of the front end parts 121M and the rear end parts 121N decreases, which can result in variation in the value of the sum total T in Expression (1).

For such a reason, to secure calculation accuracy of the flexibility F by securing accuracy of the sum total T, it is necessary to select only the fibrous material 120 of the first kind and select none of the fibrous materials 120 of the second to the fourth kinds.

After selecting the one fibrous material 120 for the calculation of the flexibility F, the following series of parameters are checked based on the electron micrograph.

Firstly, focusing on the carbon fiber part 121, the dimension of the carbon fiber part 121 in the extending direction Z, i.e., the distance (the length L1) from the front end 121E1 to the rear end 121E2 is measured. Note that the value of the length L1 is rounded to one decimal place.

Secondly, focusing on the exposed parts 121Y, the respective dimensions (the respective lengths L3) of the exposed parts 121Y in the extending direction Z are measured, following which the sum total L2 of the lengths L3 is calculated. Note that the values of the sum total L2 and the lengths L3 are each rounded to one decimal place.

Thirdly, focusing on the carbon covering parts 122, the number of the front ends 122E1 and the number of the rear ends 122E2 are each counted to calculate the sum total T of the number of the front ends 122E1 and the number of the rear ends 122E2. As described above, the sum total T becomes the following value: number of carbon covering parts 122× 2.

When each of the lengths L1 and L3 is to be measured, each of the lengths L1 and L3 may be measured by a human, or may be measured mechanically with use of, for example, image processing software.

When each of the number of the front ends 122E1 and the number of the rear ends 122E2 is to be counted, each of the number of the front ends 122E1 and the number of the rear ends 122E2 may be counted by a human, or may be counted mechanically with use of, for example, the image processing software.

The image processing software is not particularly limited in kind, and specific examples thereof include image editing software such as GIMP (v2. 10. 10). Needless to say, the foregoing image editing software may be of another version.

Thereafter, the flexibility F is calculated by Expression (1), based on the length L1, the sum total L2, and the sum total T.

Thereafter, the foregoing procedure for calculating the flexibility F is repeated ten times. In this case, each time the flexibility F is to be calculated, a different fibrous material 120 is used for the calculation of the flexibility F. The flexibility F is thus calculated for each of ten fibrous materials 120. As a result, ten flexibilities F are obtained.

Lastly, an average value of the ten flexibilities F is calculated, and the calculated average value is set to a final flexibility F. One reason why the average value is set to the final flexibility F is that reducing the variation in the flexibility F secures accuracy or reproducibility of the flexibility F. The flexibility F is thus calculated.

### [Diameter]

The carbon covering part 122 covers the surface of the carbon fiber part 121 as described above, and thus has a diameter D (nm), as illustrated in FIG. 4. As is apparent from FIG. 4, the diameter D is a dimension of the carbon covering part 122 in a direction intersecting the extending direction Z. The direction intersecting the extending direction Z corresponds to an up-down direction in FIG. 4.

Although not particularly limited, the diameter D is preferably within a range from 75 nm to 250 nm both inclusive, in particular. One reason for this is that this allows the diameter D to be appropriate, which makes it easier for the fibrous material 120 to be bent also in the carbon covering part 122 and makes it easier for such a carbon covering part 122 to hold a sufficient amount of the positive electrode active material 110.

The diameter D is calculated by the following procedure. Note that as with the calculation of the flexibility F, when the secondary battery is used to calculate the diameter D, the positive electrode 100 is collected from the secondary battery, and the diameter D is thereafter calculated by the following procedure.

First, an observation result, e.g., an electron micrograph, of the section of the positive electrode 100 is acquired by a procedure similar to that for the calculation of the flexibility F. Thereafter, one carbon covering part 122 for the calculation of the diameter D is selected, following which the diameter D of the selected carbon covering part 122 is measured. If the diameter D varies depending on a measurement position, due to the shape of the carbon covering part 122, a maximum value is selected from a plurality of diameters D measured at a plurality of measurement positions. In this case, the diameter D may be measured by a human, or may be measured mechanically with use of, for example, image processing software. Details of the image processing software are as described above. Note that the value of the diameter D is rounded to one decimal place.

Lastly, the foregoing procedure for calculating the diameter D is repeated ten times, following which an average value of the ten diameters D is calculated. The calculated average value is set to a final diameter D. In this case, each time the diameter D is to be calculated, a different carbon covering part 122 is used for the calculation of the diameter D. One reason why the average value is set to the final diameter D is that reducing the variation in the diameter D secures accuracy or reproducibility of the diameter D. The diameter D is thus calculated.

### [Other Components]

Note that the positive electrode active material layer 100B may further include any one or more of other materials including, without limitation, a positive electrode binder and a positive electrode conductor.

The positive electrode conductor includes any one or more of electrically conductive materials including, without limitation, a carbon material, a metal material, and an electrically conductive polymer compound. Specific examples of the carbon material include activated carbon, graphite, carbon black, acetylene black, and Ketjen black.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

### [1-2. Operation]

In the positive electrode 100, upon the electrode reaction, lithium is inserted into the positive electrode active material 110 in an ionic state, and is extracted from the positive electrode active material 110 in the ionic state.

### [1-3. Manufacturing Method]

The positive electrode 100 is manufactured by the following example procedure. The description below deals with a case where the carbon covering parts 122 have the fine pores 122K, and the positive electrode active material 110 is disposed in the fine pores 122K as illustrated in FIG. 3.

### [Manufacturing Procedure]

When the positive electrode 100 is to be manufactured, first, a solution including a material to be included in the carbon fiber part 121, i.e., a plurality of fibrous carbon materials, and a solution including a material to be included in the carbon covering part 122, i.e., a carbon source in powder form, are mixed with each other to obtain a mixture solution. In this case, in order to improve dispersibility of each of the fibrous carbon materials and the carbon source in the powder form, a dispersant may be included in the mixture solution. The dispersant is not particularly limited in kind, and specific examples thereof include a polymer compound such as carboxymethyl cellulose.

Thereafter, the mixture solution is put into a pressure vessel to subject the mixture solution to a hydrothermal treatment. The pressure vessel is not particularly limited in kind, and specific examples thereof include an autoclave. Note that conditions of the hydrothermal treatment including, without limitation, a heating temperature and a heating time may be set as desired. Thereafter, the mixture solution subjected to the hydrothermal treatment is filtered to collect a reaction product in powder form, following which the collected reaction product is dried.

Thereafter, the reaction product and zinc chloride (ZnCl₂) are mixed with each other to obtain a mixture, following which the mixture is heated in an inert atmosphere. The inert atmosphere is not particularly limited in kind, and specific examples thereof include a nitrogen atmosphere. Note that conditions of the heating including, without limitation, a heating temperature and a heating time may be set as desired.

As a result, the carbon covering part 122 (activated carbon) is formed on the surface of the carbon fiber part 121 with use of the carbon source. The surface of the carbon fiber part 121 is thus covered with the carbon covering part 122. In this case, the carbon covering part 122 is provided with the fine pores 122K. A precursor for forming the fibrous materials 120 is thus obtained.

The precursor has a configuration similar to that of the fibrous materials 120 except for the following points. That is, the carbon covering part 122 covers the entire surface of the carbon fiber part 121, and the carbon fiber part 121 thus does not include the exposed parts 121Y. Further, the carbon covering part 122 does not hold the positive electrode active material 110.

Thereafter, the precursor is put int to an acid aqueous solution, following which the acid aqueous solution is subjected to ultrasonic irradiation. The acid aqueous solution is not particularly limited in kind, and specific examples thereof include a hydrochloric acid aqueous solution. Note that conditions of the ultrasonic irradiation including, without limitation, an irradiation intensity and an irradiation time may be set as desired. A zinc-based residue such as zinc oxide is thus removed from the precursor.

In the ultrasonic irradiation process, the carbon covering part 122 covering the surface of the carbon fiber part 121 is partially removed at multiple locations, which exposes the carbon fiber part 121 at the locations at which the carbon covering part 122 is removed. As a result, the carbon covering parts 122 spaced from each other in the extending direction Z are formed, and the carbon fiber part 121 including the unexposed parts 121X and the exposed parts 121Y is obtained. The fibrous materials 120 each including the carbon fiber part 121 and the carbon covering parts 122 are thus formed.

Thereafter, the hydrochloric acid aqueous solution is filtered to collect the fibrous materials 120, following which the collected fibrous materials 120 are cleaned by a cleaning solvent. The cleaning solvent is not particularly limited in kind, and specific examples thereof include an aqueous solvent such as pure water or alcohol. Specific examples of the alcohol include ethanol. In this case, the fibrous materials 120 may be subjected to ultrasonic cleaning. The cleaning process of the fibrous materials 120 may be repeated multiple times. When the cleaning process is repeated multiple times, for example, the kind of the cleaning solvent or whether to perform the ultrasonic cleaning may be changed each time the cleaning process is to be performed. Note that conditions of the cleaning including, without limitation, a cleaning time may be set as desired. After cleaning the fibrous materials 120, the cleaned fibrous materials 120 are dried.

Thereafter, the fibrous materials 120 and the positive electrode active material 110 (the sulfur-containing material in powder form) are mixed with each other to obtain a mixture, following which the mixture is heated. Note that conditions of the heating including, without limitation, a heating temperature and a heating time may be set as desired. As a result, the positive electrode active material 110 is disposed in the fine pores 122K, and is thus held by the carbon covering parts 122. The fibrous materials 120 (each including the carbon fiber part 121 and the carbon covering parts 122) holding the positive electrode active material 110 is thus formed.

Thereafter, the fibrous materials 120 holding the positive electrode active material 110, the positive electrode binder, and the positive electrode conductor are mixed with each other to obtain a positive electrode mixture. Thereafter, the positive electrode mixture is put into a solvent to thereby prepare a positive electrode mixture slurry in paste form. The solvent may be an aqueous solvent, or may be an organic solvent. Thereafter, the positive electrode mixture slurry is applied on one of or each of the two opposed surfaces of the positive electrode current collector 100A to thereby form the positive electrode active material layers 100B. Lastly, the positive electrode active material layers 100B may be compression-molded by, for example, a roll pressing machine. In this case, the positive electrode active material layers 100B may be heated. The positive electrode active material layers 100B may be compression-molded multiple times.

The positive electrode active material layers 100B are thus formed on the positive electrode current collector 100A. As a result, the positive electrode 100 is completed.

### [Adjustment Procedure]

When the positive electrode 100 is to be manufactured, the flexibility F and the diameter D are each adjustable by the following procedure.

When the flexibility F is to be adjusted, in the process of subjecting the acid aqueous solution including the precursor to the ultrasonic irradiation, the conditions including, without limitation, the irradiation intensity and the irradiation time of the ultrasonic waves are changed. Specifically, when the length L1 is unchanged, the conditions including, without limitation, the irradiation intensity and the irradiation time of the ultrasonic waves described above are changed. This changes each of the number of the exposed parts 121Y, the length L3, the number of the front ends 122E1, and the number of the rear ends 122E2, and thus changes the flexibility F. In this case, an increase in each of the irradiation intensity and the irradiation time results in an increase in the flexibility F, and a decrease in each of the irradiation intensity and the irradiation time results in a decrease in the flexibility F.

When the diameter D is to be adjusted, in the process of obtaining the mixture solution, a mixture ratio between the solution including the material to be included in the carbon fiber part 121, i.e., the fibrous carbon materials, and the solution including the material to be included in the carbon covering parts 122, i.e., the carbon source in the powder form, is changed. Specifically, when a mixture amount of the latter solution is unchanged, a mixture amount of the former solution is changed. This changes an amount of the carbon covering part 122 formed on the surface of the carbon fiber part 121, and thus changes the diameter D. In this case, an increase in the mixture amount of the former solution results in an increase in the diameter D, and a decrease in the mixture amount of the former solution results in a decrease in the diameter D.

### [1-4. Action and Effects]

According to the positive electrode 100, the positive electrode 100 includes the positive electrode active material 110 and the fibrous materials 120. The positive electrode active material 110 includes the sulfur-containing material. The fibrous materials 120 are tangled with each other and form the three-dimensional mesh structure. The fibrous material 120 includes the carbon fiber part 121 and the carbon covering parts 122. The carbon covering parts 122 cover the surface of the carbon fiber part 121 and hold the positive electrode active material 110. The carbon covering parts 122 are spaced from each other in the extending direction Z. The carbon fiber part 121 includes the exposed parts 121Y that are not covered with the carbon covering parts 122. The carbon covering parts 122 each have the front end 122E1 and the rear end 122E2. Further, the fibrous materials 120 have the flexibility F within the range from 8.6 to 19.2 both inclusive.

In this case, the flexible characteristic of the fibrous materials 120 is made appropriate as described above. Accordingly, while the three-dimensional electrically conductive network formed by the carbon fiber parts 121 is maintained, and the lithium insertability and extractability in each of the carbon covering parts 122 (the positive electrode active material 110) are secured, the density of the positive electrode active material layer 100B increases. The electrode density of the positive electrode 100 thus increases. This makes it possible for the secondary battery including the positive electrode 100 to obtain a superior battery characteristic, and thus makes it possible to achieve a secondary battery having the superior battery characteristic.

In particular, the carbon fiber part 121 may have the front end part 121M and the rear end part 121N. One of or each of the front end part 121M and the rear end part 121N may be one of the exposed parts 121Y. This makes it easier for the entire fibrous material 120 to be bent, which further increases the electrode density of the positive electrode 100. Accordingly, it is possible to achieve higher effects.

Further, the carbon covering parts 122 may have the diameter D within the range from 75 nm to 250 nm both inclusive. This makes it easier for the fibrous material 120 to be bent also in the carbon covering parts 122, and makes it easier for such carbon covering parts 122 to hold a sufficient amount of the positive electrode active material 110. This allows for a sufficient increase in the electrode density of the positive electrode 100, while the energy density is secured. Accordingly, it is possible to achieve higher effects.

Further, the carbon covering parts 122 may have the fine pores 122K. The positive electrode active material 110 (the sulfur-containing material) may be disposed in the fine pores 122K. This makes it easier for the positive electrode active material 110 to be held by the carbon covering parts 122 and makes it easier for the positive electrode active material 110 and the carbon covering parts 122 to be communicable with each other, which in turn makes it easier for lithium to be stably and smoothly inserted into and extracted from the positive electrode active material layer 100B. Accordingly, it is possible to achieve higher effects.

Further, the carbon fiber part 121 may include the carbon nanotube, the carbon nanofiber, or both. This makes it easier for the three-dimensional electrically conductive network to be stably formed by the carbon fiber parts 121. Further, the carbon covering parts 122 may each include activated carbon. This makes it easier for the fine pores 122K to be stably formed in the carbon covering parts 122, and makes it easier for the positive electrode active material 110 to be stably disposed in the fine pores 122K. Accordingly, it is possible to achieve higher effects.

### 2. SECONDARY BATTERY

Next, a description is given of a secondary battery of an embodiment of the technology to which the positive electrode 100 is to be applied.

The secondary battery is a secondary battery in which a battery capacity is obtained through insertion and extraction of an electrode reactant, and includes a positive electrode, a negative electrode, and an electrolytic solution. The following description deals with an example case where the electrode reactant is lithium as described above.

### [2-1. Configuration]

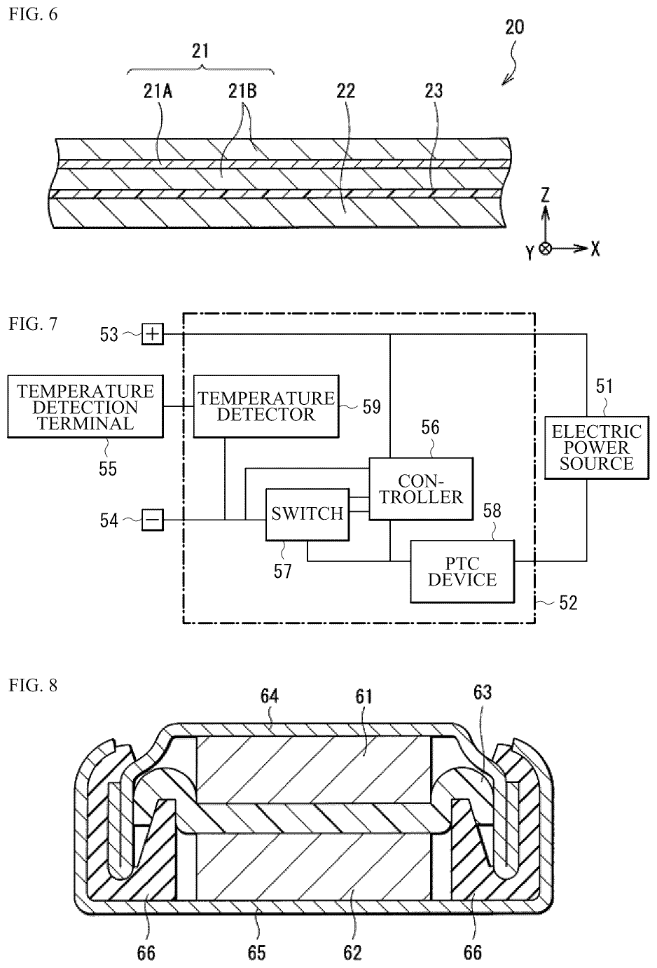

FIG. 5 illustrates a perspective configuration of the secondary battery. FIG. 6 illustrates a sectional configuration of a battery device 20 illustrated in FIG. 5. Note that FIG. 5 illustrates a state where an outer package film 10 and the battery device 20 are separated from each other, and illustrates a section of the battery device 20 along an XZ plane by a dashed line.

As illustrated in FIGS. 5 and 6, the secondary battery includes the outer package film 10, the battery device 20, a positive electrode lead 31, a negative electrode lead 32, and sealing films 41 and 42.

The secondary battery described here includes the outer package film 10 that is flexible or soft as an outer package member that is to contain the battery device 20 as described above, and is thus a secondary battery of what is called a laminated-film type.

### [Outer Package Film]

As illustrated in FIG. 5, the outer package film 10 has a pouch-shaped structure that is sealed in a state where the battery device 20 is contained inside the outer package film 10. The outer package film 10 thus contains a positive electrode 21, a negative electrode 22, a separator 23, and an electrolytic solution that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state where the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

### [Battery Device]

The battery device 20 is contained in the outer package film 10. The battery device 20 is what is called a power generation device, and includes, as illustrated in FIGS. 5 and 6, the positive electrode 21, the negative electrode 22, the separator 23, and the electrolytic solution (not illustrated).

Here, the battery device 20 is what is called a wound electrode body. That is, the positive electrode 21 and the negative electrode 22 are wound about a winding axis P, being opposed to each other with the separator 23 interposed therebetween. As is apparent from FIG. 5, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

### [Positive Electrode]

The positive electrode 21 has a configuration similar to that of the positive electrode 100. That is, the positive electrode 21 includes a positive electrode current collector 21A and a positive electrode active material layer 21B, as illustrated in FIG. 6. The positive electrode current collector 21A has a configuration similar to that of the positive electrode current collector 100A. The positive electrode active material layer 21B has a configuration similar to that of the positive electrode active material layer 100B.

Here, the positive electrode active material layer 21B is provided on each of the two opposed surfaces of the positive electrode current collector 21A. Note that the positive electrode active material layer 21B may be provided only on one of the two opposed surfaces of the positive electrode current collector 21A.

### [Negative Electrode]

As illustrated in FIG. 6, the negative electrode 22 includes a negative electrode active material. The negative electrode active material includes an alkali metal material, and the alkali metal material includes any one or more of alkali metal elements as one or more constituent elements. Note that only one alkali metal element may be included, or two or more alkali metal elements may be included. The alkali metal material may be a simple substance, an alloy, a compound, or a material including two or more thereof.

Here, the alkali metal material includes an alkali metal (what is called a simple substance of an alkali metal). One reason for this is that a sufficient battery capacity is obtainable. The “simple substance” described here is as described above. That is, the simple substance may include any amount of impurity, and purity of the simple substance thus does not necessarily have to be 100%.

The alkali metal is not particularly limited in kind, and specific examples thereof include lithium, sodium, and potassium.

In particular, the alkali metal is preferably lithium, as described above. One reason for this is that coulombic efficiency further improves. A secondary battery in which the positive electrode 21 includes the positive electrode active material (the sulfur-containing material) and the negative electrode 22 includes the negative electrode active material (lithium) is what is called a lithium-sulfur secondary battery. In this case, the negative electrode 22 may be a lithium metal plate, and may thus include lithium metal as the negative electrode active material (the alkali metal).

### [Separator]

The separator 23 is an insulating porous film interposed between the positive electrode 21 and the negative electrode 22 as illustrated in FIG. 6, and allows lithium to pass therethrough in an ionic state while preventing occurrence of a short circuit caused by contact between the positive electrode 21 and the negative electrode 22. The separator 23 includes a polymer compound such as polyethylene.

### [Electrolytic Solution]

The electrolytic solution is a liquid electrolyte. The positive electrode 21 and the separator 23 are each impregnated with the electrolytic solution. The electrolytic solution includes a solvent and an electrolyte salt.

The solvent includes any one or more of non-aqueous solvents (organic solvents), and the electrolytic solution including the one or more non-aqueous solvents is what is called a non-aqueous electrolytic solution.

The non-aqueous solvent includes, for example, an ester or an ether, more specifically, any one or more of a carbonic-acid-ester-based compound, a carboxylic-acid-ester-based compound, or a lactone-based compound. One reason for this is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

Further, the non-aqueous solvent includes any one or more of solvents including, without limitation, an unsaturated cyclic carbonic acid ester, a fluorinated cyclic carbonic acid ester, a sulfonic acid ester, a phosphoric acid ester, an acid anhydride, a nitrile compound, and an isocyanate compound. One reason for this is that the dissociation property of the electrolyte salt and mobility of ions improve similarly.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

Needless to say, the non-aqueous solvent is not particularly limited in composition as long as the non-aqueous solvent includes any one or more of the above-described series of options for the non-aqueous solvent, and may thus have a composition set as desired.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl)methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that high ion conductivity is obtainable.

### [Positive Electrode Lead]

As illustrated in FIGS. 5 and 6, the positive electrode lead 31 is a positive electrode wiring coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 has any one of shapes including, without limitation, a thin plate shape and a meshed shape.

### [Negative Electrode Lead]

As illustrated in FIGS. 5 and 6, the negative electrode lead 32 is a negative electrode wiring coupled to the negative electrode 22, and is led to the outside of the outer package film 10. Here, the negative electrode lead 32 is led in a direction similar to a direction in which the positive electrode lead 31 is led. The negative electrode lead 32 includes an electrically conductive material such as a metal material. Specific examples of the electrically conductive material include copper. Note that details of a shape of the negative electrode lead 32 are similar to those of the shape of the positive electrode lead 31.

### [Sealing Films]

The sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

### [2-2. Operation]

The secondary battery operates as described below in the battery device 20.

Upon discharging, lithium is extracted from the negative electrode 22, and the extracted lithium is inserted into the positive electrode 21 via the electrolytic solution. Upon charging, lithium is extracted from the positive electrode 21, and the extracted lithium is inserted into the negative electrode 22 via the electrolytic solution. Upon each of the discharging and the charging, lithium is inserted and extracted in an ionic state.

### [2-3. Manufacturing Method]

When the secondary battery is to be manufactured, the positive electrode 21 is fabricated and the electrolytic solution is prepared, following which the secondary battery is assembled using the positive electrode 21, the negative electrode 22, and the electrolytic solution, and the assembled secondary battery is subjected to a stabilization process, in accordance with an example procedure described below.

### [Fabrication of Positive Electrode]

First, the positive electrode 21 is fabricated in accordance with a procedure similar to the manufacturing procedure of the positive electrode 100. In this case, the positive electrode active material layer 21B is formed on the positive electrode current collector 21A.

### [Preparation of Electrolytic Solution]

The electrolyte salt is put into the solvent. The electrolyte salt is thereby dispersed or dissolved in the solvent. The electrolytic solution is thus prepared.

### [Assembly of Secondary Battery]

First, the negative electrode 22 including the alkali metal is prepared. In this case, for example, the lithium metal plate is used as the negative electrode 22. Thereafter, the positive electrode lead 31 is coupled to the positive electrode current collector 21A of the positive electrode 21 by a joining method such as a welding method, and the negative electrode lead 32 is coupled to the negative electrode 22 by the joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). Thereafter, the wound body is pressed by, for example, a pressing machine to thereby shape the wound body into an elongated shape. The shaped wound body has a configuration similar to that of the battery device 20 except that the positive electrode 21, the negative electrode 22, and the separator 23 are each not impregnated with the electrolytic solution.

Thereafter, the wound body is placed inside the depression part 10U, following which the outer package film 10 (the fusion-bonding layer/the metal layer/the surface protective layer) is folded to thereby cause portions of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained inside the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus formed. Accordingly, the battery device 20 is sealed in the outer package film 10 having the pouch shape. The secondary battery is thus assembled.

### [Stabilization of Secondary Battery]

The assembled secondary battery is charged and discharged. Various conditions including, for example, an environment temperature, the number of times of charging and discharging (the number of cycles), and charging and discharging conditions may be set as desired. As a result, the positive electrode 21 and the negative electrode 22 are each brought into an electrochemically stabilized state. The secondary battery is thus completed.

### [2-4. Action and Effects]

According to the above-described secondary battery, the positive electrode active material layer 21B of the positive electrode 21 has the configuration similar to that of the positive electrode 100. Accordingly, for the reasons described above, in the positive electrode 21, while the three-dimensional electrically conductive network is maintained and the lithium insertability and extractability are secured, the density of the positive electrode active material layer 21B increases. This increases the electrode density of the positive electrode 21. Accordingly, it is possible to obtain a secondary battery having a superior battery characteristic.

In particular, the negative electrode 22 may include the alkali metal. This makes it possible to stably obtain a sufficient battery capacity through insertion and extraction of alkali metal. Accordingly, it is possible to achieve higher effects. In this case, the alkali metal may include lithium. This makes it possible to further improve the coulombic efficiency. Accordingly, it is possible to achieve even higher effects.

Further, the secondary battery may include a lithium-sulfur secondary battery. This makes it possible to stably obtain a sufficient battery capacity through the insertion and extraction of lithium. Accordingly, it is possible to achieve higher effects.

### 3. MODIFICATION EXAMPLES

The configuration of the secondary battery is appropriately modifiable as described below. Note that any of the following series of modification examples may be combined with each other.

### Modification Example 1

In FIG. 1, the positive electrode 100 includes the positive electrode current collector 100A and the positive electrode active material layer 100B. However, the positive electrode 100 does not have to include the positive electrode current collector 100A and may include only the positive electrode active material layer 100B. In this case also, while the three-dimensional electrically conductive network is maintained and the lithium insertability and extractability are secured, the density of the positive electrode active material layer 100B increases, as described above. This increases the electrode density of the positive electrode 100. Accordingly, it is possible to achieve similar effects.

### Modification Example 2

In FIG. 6, the separator 23 that is the porous film is used. However, although not specifically illustrated here, a separator of a stacked type including a polymer compound layer may be used instead of the separator 23 that is the porous film.

Specifically, the separator of the stacked type includes a porous film having two opposed surfaces, and the polymer compound layer provided on one of or each of the two opposed surfaces of the porous film. One reason for this is that this improves adherence of the separator to each of the positive electrode 21 and the negative electrode 22, and therefore suppresses misalignment of the battery device 20, that is, winding displacement of each of the positive electrode 21, the negative electrode 22, and the separator. This suppresses swelling of the secondary battery even if a decomposition reaction of the electrolytic solution occurs. The polymer compound layer includes a polymer compound such as polyvinylidene difluoride. One reason for this is that the polymer compound such as polyvinylidene difluoride is superior in physical strength and is electrochemically stable.

Note that the porous film, the polymer compound layer, or both may each include any one or more kinds of insulating particles. One reason for this is that the insulating particles dissipate heat upon heat generation by the secondary battery, thus improving safety or heat resistance of the secondary battery. Examples of the insulating particles include inorganic particles and resin particles. The inorganic particles include any one or more of inorganic materials including, without limitation, aluminum oxide, aluminum nitride, boehmite, silicon oxide, titanium oxide, magnesium oxide, and zirconium oxide. The resin particles include any one or more of resin materials including, without limitation, an acrylic resin and a styrene resin.

When the separator of the stacked type is to be fabricated, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed by suppression of the misalignment of the battery device 20, as described above. Accordingly, it is possible to achieve higher effects.

### Modification Example 3

In FIG. 6, the electrolytic solution, which is a liquid electrolyte, is used. However, although not specifically illustrated here, an electrolyte layer that is a gel electrolyte may be used instead of the electrolytic solution.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that leakage of the electrolytic solution is suppressed. The electrolytic solution has the configuration described above. The polymer compound includes, for example, polyvinylidene difluoride. When the electrolyte layer is to be formed, a precursor solution including, without limitation, the electrolytic solution, the polymer compound, and an organic solvent is prepared, following which the precursor solution is applied on one side or both sides of the positive electrode 21 and on one side or both sides of the negative electrode 22.

When the electrolyte layer is used also, lithium is movable in an ionic state between the positive electrode 21 and the negative electrode 22 via the electrolyte layer, and similar effects are therefore achievable. In this case, in particular, the leakage of the electrolytic solution is suppressed, as described above. Accordingly, it is possible to achieve higher effects.

### 4. APPLICATIONS OF SECONDARY BATTERY

Lastly, a description is given of applications (application examples) of the secondary battery.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

FIG. 7 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 7, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to an outside via the positive electrode terminal 53 and the negative electrode terminal 54, and is thus chargeable and dischargeable. The circuit board 52 includes a controller 56, a switch 57, a thermosensitive resistive device (what is called a PTC device) 58, and a temperature detector 59. However, the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the technology.

### Examples 1 to 10 and Comparative Examples 1 to 4

Secondary batteries were fabricated, following which the secondary batteries were each evaluated for a battery characteristic, as described below.

### [Manufacturing of Secondary Battery]

The secondary battery was manufactured by the following procedure.

Here, a test secondary battery was fabricated to conduct a simple evaluation as the evaluation for the battery characteristic. FIG. 8 illustrates a sectional configuration of the test secondary battery (a lithium-ion secondary battery of a coin type).

As illustrated in FIG. 8, the secondary battery included a test electrode 61, a counter electrode 62, a separator 63, an outer package cup 64, an outer package can 65, a gasket 66, and an electrolytic solution (not illustrated). Here, the test electrode 61 served as a positive electrode, and the counter electrode 62 served as a negative electrode.

The test electrode 61 was placed inside the outer package cup 64, and the counter electrode 62 was placed inside the outer package can 65. The test electrode 61 and the counter electrode 62 were stacked on each other with the separator 63 interposed therebetween. The test electrode 61, the counter electrode 62, and the separator 63 were each impregnated with the electrolytic solution. The outer package cup 64 and the outer package can 65 were crimped to each other with the gasket 66 interposed therebetween. The test electrode 61, the counter electrode 62, and the separator 63 were each thus sealed in the outer package cup 64 and the outer package can 65.

### [Fabrication of Test Electrode (Positive Electrode)]

When the test electrode 61 was to be fabricated, first, an aqueous solution (having a concentration of fibrous carbon materials of 0.2 wt %) including a material (single-walled carbon nanotubes (SWCNTs) as the fibrous carbon materials) to be included in the carbon fiber part 121 and a dispersant (carboxymethyl cellulose), and an aqueous solution (having a concentration of 1 mol/l (=1 mol/dm³) including a material (xylose as a carbon source in powder form) to be included in the carbon covering parts 122 were mixed with each other to obtain a mixture solution. In this case, a mixture ratio (a weight ratio) between the two aqueous solutions was changed to change the diameter D (nm) of the carbon covering parts 122 to be formed in a later process.

Thereafter, the mixture solution was put into a pressure vessel (an autoclave) to subject the mixture solution to a hydrothermal treatment (at a heating temperature of 220° C. and for a heating time of five hours). Thereafter, the mixture solution subjected to the hydrothermal treatment was filtered to collect a reaction product in powder form, following which the collected reaction product was dried.

Thereafter, the reaction product and zinc chloride (ZnCl₂) were mixed with each other to obtain a mixture, following which the mixture was heated (at a heating temperature of 800° C. and for a heating time of one hour) in an inert atmosphere (a nitrogen atmosphere). As a result, the carbon covering part 122 (activated carbon) was formed on the surface of the carbon fiber part 121 (SWCNT) with use of the carbon source, and the carbon covering part 122 was provided with the fine pores 122K. A precursor was thus obtained.

Thereafter, the precursor was put into an acid aqueous solution (a hydrochloric acid aqueous solution), following which the acid aqueous solution was subjected to ultrasonic irradiation. In this case, conditions (an irradiation intensity and an irradiation time) of the ultrasonic irradiation were changed to change the flexibility F of the fibrous material 120 that was to be formed in a later process. The fibrous materials 120 each including the carbon fiber part 121 and the carbon covering parts 122 were thus formed.

Thereafter, the hydrochloric acid aqueous solution was filtered to collect the fibrous materials 120. Thereafter, the collected fibrous materials 120 were subjected to ultrasonic cleaning (for a cleaning time of one hour) by a cleaning solvent (ethanol), following which the cleaning solvent was filtered. Thereafter, the fibrous materials 120 were subjected to ultrasonic cleaning (for a cleaning time of one hour) by a cleaning solvent (pure water), following which the cleaning solvent was filtered. Thereafter, the fibrous materials 120 subjected to the cleaning were dried.

Thereafter, the fibrous materials 120 and the positive electrode active material 110 (a simple substance of sulfur as a sulfur-containing material in powder form) were mixed with each other to obtain a mixture, following which the mixture was heated (at a heating temperature of 150° C. and for a heating time of one hour). In this case, a mixture ratio (a weight ratio) between the fibrous materials 120 and the positive electrode active material 110 was set to 40:60. This allowed the positive electrode active material 110 to be disposed in the fine pores 122K, and the positive electrode active material 110 was thus held by each of the carbon covering parts 122.

The fibrous materials 120 (including the carbon fiber part 121 and the carbon covering parts 122) holding the positive electrode active material 110 were thus formed.

Thereafter, the fibrous materials 120 holding the positive electrode active material 110, a positive electrode binder (a styrene-butadiene rubber), a positive electrode conductor (acetylene black), and a thickener (carboxymethyl cellulose) were mixed with each other to obtain a positive electrode mixture. In this case, a mixture ratio (a weight ratio) was set to 68:17:9:6.

Thereafter, the positive electrode mixture was put into a solvent (pure water as an aqueous solvent), following which the solvent was stirred to thereby prepare a positive electrode mixture slurry in paste form. Thereafter, the positive electrode mixture slurry was applied on one of the two opposed surfaces of the positive electrode current collector 21A (an aluminum foil having a thickness of 21 μm) by a coating apparatus, following which the applied positive electrode mixture slurry was dried to thereby form the positive electrode active material layer 21B. Lastly, the positive electrode current collector 21A with the positive electrode active material layer 21B formed thereon was punched into a disk shape (having a diameter of 15 mm). The test electrode 61 including the positive electrode current collector 21A and the positive electrode active material layer 21B was thus fabricated.

After the completion of the test electrode 61, the secondary battery was checked in terms of each of the flexibility F and the diameter D (nm), which revealed the results presented in Table 1. An adjustment procedure of each of the flexibility F and the diameter D, a calculation procedure of the flexibility F, and a measurement procedure of the diameter D were as described above.

A test electrode 61 for comparison was fabricated by a similar procedure except that the acid aqueous solution including the precursor was not subjected to the ultrasonic irradiation. In this case, partial removement of the carbon covering part 122 from the carbon fiber part 121 did not occur, which resulted in no formation of the exposed parts 121Y. Accordingly, the flexibility F was 0 (zero).

### [Fabrication of Counter Electrode (Negative Electrode)]

An alkali metal (a lithium metal plate) as the negative electrode active material was punched into a disk shape (having a diameter of 16 mm). The counter electrode 62 was thus obtained.

### [Preparation of Electrolytic Solution]

An electrolyte salt (lithium bis(trifluoromethanesulfonyl)imide) was added to a solvent (vinylene carbonate as an unsaturated cyclic carbonic acid ester, and monofluoroethylene carbonate as a fluorinated cyclic carbonic acid ester), following which the solvent was stirred. In this case, a mixture ratio (a volume ratio) of the solvent was set to 50:50, and a content of the electrolyte salt with respect to the solvent was set to 1 mol/l (=1 mol/dm³). The electrolytic solution was thus prepared.

### [Assembly of Secondary Battery]

First, the test electrode 61 was placed in the outer package cup 64, and the counter electrode 62 was placed in the outer package can 65. Thereafter, the test electrode 61 placed in the outer package cup 64 and the counter electrode 62 placed in the outer package can 65 were stacked on each other with the separator 63 (a dry separator Celgard 3501 available from Celgard inc.), impregnated with the electrolytic solution, interposed therebetween. Lastly, the outer package cup 64 and the outer package can 65 were crimped to each other by the gasket 66 in a state where the test electrode 61 and the counter electrode 62 were stacked on each other with the separator 63 interposed therebetween. The test electrode 61 and the counter electrode 62 were thereby sealed in the outer package cup 64 and the outer package can 65. The secondary battery was thus assembled.

### [Stabilization of Secondary Battery]

The secondary battery was charged and discharged for three cycles in an ambient temperature environment (at a temperature of 25° C.). In this case, upon discharging, the secondary battery was discharged with a constant current of 0.05 C until a voltage reached 1.0 V, and upon charging, the secondary battery was charged with a constant current of 0.05 C until the voltage reached 3.0 V. Note that 0.05 C was a value of a current that caused a battery capacity (a theoretical capacity) to be completely discharged in 20 hours.

As a result, the test electrode 61 and the counter electrode 62 were each brought into an electrochemically stabilized state. The secondary battery was thus completed.

### [Evaluation of Battery Characteristic]

The secondary batteries were each evaluated for each of an electrode characteristic and a discharge characteristic as the battery characteristic, which revealed the results presented in Table 1.

### [Electrode Characteristic]

First, the secondary battery was disassembled to collect the test electrode 61, following which a weight (g) and a thickness (cm) of the test electrode 61 were measured. Thereafter, the positive electrode current collector 21A was peeled off from the positive electrode active material layer 21B by a scraper, following which a weight (g) and a thickness (cm) of the positive electrode current collector 21A were measured. Thereafter, a weight (g) and a volume (cc (=cm³)) of the positive electrode active material layer 21B were calculated. When the weight of the positive electrode active material layer 21B was to be measured, the weight of the positive electrode current collector 21A was subtracted from the weight of the test electrode 61. When the volume of the positive electrode active material layer 21B was to be measured, a thickness (cm) of the positive electrode active material layer 21B was calculated by subtracting the thickness of the positive electrode current collector 21A from the thickness of the test electrode 61, following which the volume was calculated based on the diameter (cm) and the thickness of the positive electrode active material layer 21B. An electrode density that was an index for evaluating the electrode characteristic was thereby calculated based on the following calculation expression: electrode density (g/cm³)=weight of positive electrode active material layer 21B/volume of positive electrode active material layer 21B.

### [Discharge Characteristic]

First, the secondary battery was charged and discharged for three cycles at an ambient temperature environment (at a temperature of 25° C.) to thereby measure a third-cycle discharge capacity (mAh). Note that charging and discharging conditions were similar to those for the stabilization of the secondary battery.

Thereafter, the positive electrode active material 110 was collected from the secondary battery, following which a weight (g) of the positive electrode active material 110 was measured, in accordance with the following procedure.

In this case, first, the secondary battery was disassembled inside a glove box (in an inert atmosphere) to thereby collect the test electrode 61. Thereafter, the test electrode 61 was immersed in a solvent (dimethyl carbonate as an organic solvent) to thereby clean the test electrode 61. Thereafter, the test electrode 61 was dried sufficiently inside the glove box, following which the weight (g) of the test electrode 61 was measured.

Thereafter, the positive electrode current collector 21A was peeled off from the positive electrode active material layer 21B with the scraper, following which the weight (g) of the positive electrode current collector 21A was measured. When the weight of the positive electrode current collector 21A was to be measured, the positive electrode current collector 21A was immersed in a lot of water contained inside a beaker, following which the positive electrode current collector 21A was subjected to ultrasonic cleaning. After thus removing a residue on the surface of the positive electrode current collector 21A, the weight of the positive electrode current collector 21A was measured.

Thereafter, the positive electrode active material layer 21B was crushed with use of a mortar to obtain a crushed material in powder form, following which the crushed material was analyzed by energy dispersive X-ray spectroscopy (EDX). A content (a mixture rate) of sulfur in the crushed material was thus measured.

The weight of the positive electrode active material layer 21B was thus calculated by subtracting the weight of the positive electrode current collector 21A from the weight of the test electrode 61, following which the weight of the positive electrode active material 110 was calculated by multiplying the calculated value of the weight of the positive electrode active material layer 21B by the sulfur mixture rate.

After the weight of the positive electrode active material 110 was measured, lastly, a weight discharge capacity that was an index for evaluating the discharge characteristic was calculated based on the following calculation expression: weight discharge capacity (mAh/g)=third-cycle discharge capacity/weight of positive electrode active material 110. The weight discharge capacity was what is called a discharge capacity per unit weight of the positive electrode active material 110.

TABLE 1

| | | Carbon | | | | | |
|---|---|---|---|---|---|---|---|
| | Positive | fiber part | Carbon covering | | | | Weight |
| | electrode | Fibrous | part | | Diameter | Electrode | discharge |
| | active | carbon | Non-fibrous | Flexibility | D | density | capacity |
| | material | material | carbon material | F | (nm) | (g/cm³) | (mAh/g) |
| Comparative example 1 | Sulfur | SWCNT | Activated carbon | 0 | 100 | 0.24 | 1421 |
| Comparative example 2 | Sulfur | SWCNT | Activated carbon | 4.2 | 100 | 0.31 | 1453 |
| Example 1 | Sulfur | SWCNT | Activated carbon | 8.6 | 100 | 0.40 | 1502 |
| Example 2 | Sulfur | SWCNT | Activated carbon | 11.3 | 100 | 0.41 | 1495 |
| Example 3 | Sulfur | SWCNT | Activated carbon | 12.2 | 100 | 0.42 | 1492 |
| Example 4 | Sulfur | SWCNT | Activated carbon | 19.2 | 100 | 0.40 | 1475 |
| Comparative example 3 | Sulfur | SWCNT | Activated carbon | 36.3 | 100 | 0.41 | 1417 |
| Comparative example 4 | Sulfur | SWCNT | Activated carbon | 95.1 | 100 | 0.35 | 1362 |
| Example 5 | Sulfur | SWCNT | Activated carbon | 12.2 | 50 | 0.30 | 1039 |
| Example 6 | Sulfur | SWCNT | Activated carbon | 12.2 | 75 | 0.36 | 1285 |
| Example 7 | Sulfur | SWCNT | Activated carbon | 12.2 | 90 | 0.39 | 1410 |
| Example 8 | Sulfur | SWCNT | Activated carbon | 12.2 | 200 | 0.40 | 1130 |
| Example 9 | Sulfur | SWCNT | Activated carbon | 12.2 | 250 | 0.43 | 1057 |
| Example 10 | Sulfur | SWCNT | Activated carbon | 12.2 | 300 | 0.42 | 1010 |

### [Discussion]

As indicated in Table 1, the electrode density and the weight discharge capacity each varied greatly depending on the configuration of the test electrode 61.

Specifically, when the flexibility F was within an appropriate range (when the flexibility F was within the range from 8.6 to 19.2 both inclusive) (Examples 1 to 4), a high electrode density of 0.40 g/cm³ or higher was obtained and a high weight discharge capacity of 1475 mAh/g or higher was obtained, unlike when the flexibility F was out of the appropriate range (Comparative examples 1 to 4).

In particular, when the flexibility F was within the appropriate range (Examples 3 and 5 to 10), if the diameter D was within an appropriate range (when the diameter D was within the range from 75 nm to 250 nm both inclusive) (Examples 3 and 6 to 9), a higher electrode density was obtained and a higher weight discharge capacity was obtained.

### CONCLUSION

Based upon the results presented in Table 1, when the flexibility F related to the secondary battery to which the positive electrode 100 was applied was within the range from 8.6 to 19.2 both inclusive, the electrode density increased and the weight discharge capacity also increased. Both the electrode characteristic and the discharge characteristic thus improved. This made it possible to achieve a secondary battery having a superior battery characteristic.

Although the technology has been described above with reference to some embodiments and Examples, the configuration of the technology is not limited to those described with reference to the embodiments and Examples above, and is therefore modifiable in a variety of ways.

Specifically, the description has been given of the case where the secondary battery has a battery structure of the laminated-film type or the coin type. However, the device structure of the secondary battery is not particularly limited, and may be, for example, of a cylindrical type, a prismatic type, or a button type.

Further, the description has been given of the case where the battery device has a device structure of a wound type. However, the device structure of the battery device is not particularly limited, and the device structure may be, for example, a stacked type or a zigzag folded type. In the stacked type, the positive electrode and the negative electrode are stacked on each other. In the zigzag folded type, the positive electrode and the negative electrode are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the technology are therefore not limited to those described herein. Accordingly, the technology may achieve any other effect.

Note that the technology may have any of the following configurations.
<1> A secondary battery including: a positive electrode including a positive electrode active material and a plurality of fibrous materials; a negative electrode; and an electrolytic solution, wherein the positive electrode active material includes a sulfur-containing material, the plurality of fibrous materials are tangled with each other and form a three-dimensional mesh structure, the plurality of fibrous materials each include: a carbon fiber part, and a plurality of carbon covering parts that cover a surface of the carbon fiber part and hold the positive electrode active material, the plurality of carbon covering parts are spaced from each other in an extending direction of the carbon fiber part, the carbon fiber part includes a plurality of exposed parts that are not covered with the carbon covering parts, the plurality of carbon covering parts each have a first end in the extending direction of the carbon fiber part, and a second end opposite to the first end, and the plurality of fibrous materials have a flexibility F that is higher than or equal to 8.6 and lower than or equal to 19.2, wherein F=(L2/L1)×T where L1 is a length, in micrometers, of the carbon fiber part in the extending direction of the carbon fiber part, L2 is a sum total, in micrometers, of respective lengths of the plurality of exposed parts in the extending direction of the carbon fiber part, and T is a sum total, in number, of a number of the first ends and a number of the second ends.
<2> The secondary battery according to <1>, in which the carbon fiber part has a first end part in the extending direction of the carbon fiber part, and a second end part opposite to the first end part, and one of or each of the first end part and the second end part is one of the plurality of exposed parts.
<3> The secondary battery according to <1> or <2>, in which the plurality of carbon covering parts have a diameter of greater than or equal to 75 nanometers and less than or equal to 250 nanometers in a direction intersecting the extending direction of the carbon fiber part.
<4> The secondary battery according to any one of <1> to <3>, in which the plurality of carbon covering parts have a plurality of fine pores, and the positive electrode active material is disposed in the plurality of fine pores.
<5> The secondary battery according to any one of <1> to <4>, in which the carbon fiber part includes a carbon nanotube, a carbon nanofiber, or both, and the plurality of carbon covering parts each include activated carbon.
<6> The secondary battery according to any one of <1> to <5>, in which the negative electrode includes an alkali metal.
<7> The secondary battery according to <6>, in which the alkali metal includes lithium.
<8> The secondary battery according to any one of <1> to <7>, in which the secondary battery includes a lithium-sulfur secondary battery.
<9> A positive electrode for a secondary battery, the positive electrode including: a positive electrode active material; and a plurality of fibrous materials; wherein the positive electrode active material includes a sulfur-containing material, the plurality of fibrous materials are tangled with each other and form a three-dimensional mesh structure, the plurality of fibrous materials each include a carbon fiber part, and a plurality of carbon covering parts that cover a surface of the carbon fiber part and hold the positive electrode active material, the plurality of carbon covering parts are spaced from each other in an extending direction of the carbon fiber part, the carbon fiber part includes a plurality of exposed parts that are not covered with the plurality of carbon covering parts, the plurality of carbon covering parts each have a first end in the extending direction of the carbon fiber part, and a second end opposite to the first end, and the plurality of fibrous materials have a flexibility F that is higher than or equal to 8.6 and lower than or equal to 19.2, wherein F=(L2/L1)×T where L1 is a length, in micrometers, of the carbon fiber part in the extending direction of the carbon fiber part, L2 is a sum total, in micrometers, of respective lengths of the plurality of exposed parts in the extending direction of the carbon fiber part, and T is a sum total, in number, of a number of the first ends and a number of the second ends.

1. A secondary battery comprising:
a positive electrode including a positive electrode active material and a plurality of fibrous materials;
a negative electrode; and
an electrolytic solution, wherein
the positive electrode active material includes a sulfur-containing material,
the plurality of fibrous materials are tangled with each other and form a three-dimensional mesh structure,
the plurality of fibrous materials each include:
a carbon fiber part, and
a plurality of carbon covering parts that cover a surface of the carbon fiber part and hold the positive electrode active material,
the plurality of carbon covering parts are spaced from each other in an extending direction of the carbon fiber part,
the carbon fiber part includes a plurality of exposed parts that are not covered with the carbon covering parts,
the plurality of carbon covering parts each have
a first end in the extending direction of the carbon fiber part, and
a second end opposite to the first end, and
the plurality of fibrous materials have a flexibility F that is higher than or equal to 8.6 and lower than or equal to 19.2, wherein
$$F = ( L 2 / L 1 ) \times T$$
where
L1 is a length, in micrometers, of the carbon fiber part in the extending direction of the carbon fiber part,
L2 is a sum total, in micrometers, of respective lengths of the plurality of exposed parts in the extending direction of the carbon fiber part, and
T is a sum total, in number, of a number of the first ends and a number of the second ends.

2. The secondary battery according to claim 1, wherein
the carbon fiber part has
a first end part in the extending direction of the carbon fiber part, and
a second end part opposite to the first end part, and
one of or each of the first end part and the second end part is one of the plurality of exposed parts.

3. The secondary battery according to claim 1, wherein the plurality of carbon covering parts have a diameter of greater than or equal to 75 nanometers and less than or equal to 250 nanometers in a direction intersecting the extending direction of the carbon fiber part.

4. The secondary battery according to claim 1, wherein
the plurality of carbon covering parts have a plurality of pores, and
the positive electrode active material is disposed in the plurality of pores.

5. The secondary battery according to claim 1, wherein
the carbon fiber part includes a carbon nanotube, a carbon nanofiber, or both, and
the plurality of carbon covering parts each include activated carbon.

6. The secondary battery according to claim 1, wherein the negative electrode includes an alkali metal.

7. The secondary battery according to claim 6, wherein the alkali metal includes lithium.

8. The secondary battery according to claim 1, wherein the secondary battery comprises a lithium-sulfur secondary battery.

9. A positive electrode for a secondary battery, the positive electrode comprising:
a positive electrode active material; and
a plurality of fibrous materials, wherein
the positive electrode active material includes a sulfur-containing material,
the plurality of fibrous materials are tangled with each other and form a three-dimensional mesh structure,
the plurality of fibrous materials each include
a carbon fiber part, and
a plurality of carbon covering parts that cover a surface of the carbon fiber part and hold the positive electrode active material,
the plurality of carbon covering parts are spaced from each other in an extending direction of the carbon fiber part,
the carbon fiber part includes a plurality of exposed parts that are not covered with the plurality of carbon covering parts,
the plurality of carbon covering parts each have
a first end in the extending direction of the carbon fiber part, and
a second end opposite to the first end, and
the plurality of fibrous materials have a flexibility F that is higher than or equal to 8.6 and lower than or equal to 19.2, wherein
$$F = ( L 2 / L 1 ) \times T$$
where
L1 is a length, in micrometers, of the carbon fiber part in the extending direction of the carbon fiber part,
L2 is a sum total, in micrometers, of respective lengths of the plurality of exposed parts in the extending direction of the carbon fiber part, and
T is a sum total, in number, of a number of the first ends and a number of the second ends.

10. The positive electrode according to claim 9, wherein
the carbon fiber part has
a first end part in the extending direction of the carbon fiber part, and
a second end part opposite to the first end part, and
one of or each of the first end part and the second end part is one of the plurality of exposed parts.

11. The positive electrode according to claim 9, wherein the plurality of carbon covering parts have a diameter of greater than or equal to 75 nanometers and less than or equal to 250 nanometers in a direction intersecting the extending direction of the carbon fiber part.

12. The positive electrode according to claim 9, wherein
the plurality of carbon covering parts have a plurality of pores, and
the positive electrode active material is disposed in the plurality of pores.

13. The positive electrode according to claim 9, wherein
the carbon fiber part includes a carbon nanotube, a carbon nanofiber, or both, and
the plurality of carbon covering parts each include activated carbon.
